(19) United States
(12) Patent Application Publication
(10) Pub. No.: US 2013/0282560 A1
(43) Pub. Date: Oct. 24, 2013

(54) APPLICATION ACCESSIBILITY SYSTEM AND METHOD

(71) Applicant: Günter Rapatz, Kennelbach (AT)

(72) Inventor: Günter Rapatz, Kennelbach (AT)

(21) Appl. No.: 13/451,198

(22) Filed: Apr. 19, 2012

(51) Int. Cl. G06F 21/22; G06Q 20/22

(52) U.S. Cl. 705/39; 726/3

(57) ABSTRACT

A system and method are provided for providing remote access to a software application over a communication network. In an embodiment, user information and authentication information are stored. An information processor provides a first instance of the software application to a computing device and captures a video stream associated with the first instance of the software application. The captured first video stream is processed to provide a first data stream that is interpretable by a web browser. The first data stream is sent to the browser, and a second data stream is received that represents input from the user. The second stream is decoded and the input represented by the stream is entered into the software application.

### BACKGROUND

1. Field

The present application relates, generally, to communications and, more particular, to managing and providing remote software application sharing.

2. Description of the Related Art

In the past, attempts have been made to provide remote and/or shared access to a software application, for example, over the Internet. For example, remote desktop services are used to enable a computer workstation (i.e., a personal computer) to be accessed from another computer. Similarly, Terminal Services RemoteApp (also referred to as Remote Desktop Services RemoteApp) enables remote access to a computer workstation. Remote desktop services typically require special server and/or client software to be installed on the server and/or client device.

Another form of remote access to software applications regards “cloud” software applications, which typically run in a web browser software application, such as MICROSOFT INTERNET EXPLORER. Typically, cloud software applications require the web browser to support Asynchronous JavaScript and XML (hereinafter “AJAX,”), which many web browser software applications do. Examples of cloud applications include GMAIL for e-mail or GOOGLE DOCS, which includes an office suite with a word processor, spreadsheet, and presentation software.

In addition to applications, remote access to on-line desktops is known, which enables remote access and sharing of files over the Internet. For example, desktop virtualization is known, which enables a desktop operating system to run on a host system that may be a dedicated system. Desktop virtualization may be provided as remote hosted desktops, remote virtual applications, remote hosted dedicated virtual desktops, local virtual applications, and local virtual operating systems. Example products for virtualization include, for example, VMWARE, CITRIX and HYPER-V. Desktop virtualization is a popular solution for delivering virtual desktops to remote and temporary users, particularly for corporate information technology providers, as it is effective solution for protecting corporate data, centralizes desktop management and speeds up desktop deployments. Moreover, operating and support costs are reduced using desktop virtualization.

Moreover, virtual appliances are known, which may include entire application stacks that are implemented as virtual machines and include everything from the operating system and web server, to a respective software application. In a typical case, images are implemented locally, such as a VMWARE image. In some cases, a virtual appliance is provided on the Internet, e.g., in the “cloud” and is accessible remotely. One known application that supports virtual machines and ported to the cloud is JUMPBOX, which may be a virtual computer that bundles an entire server-based application stack into a single unit. This is professed to make providing applications in the cloud much easier than in physical environments.

Known web-based software applications require client devices that are running web browser software applications to include plug-ins or other functional technology, such as provided by FLASH, JAVA and SILVERLIGHT. Web-based applications that run in browsers that require such technology are believed to operate at a disadvantage because the web application, typically, needs to be programmed specially for the browser. For example and with regard to virtualization, although multiple operating systems may run on a single host device, there still requires a need for a dedicated player. With regard to application streaming, such as delivered via a virtualization scheme, there remains a requirement for at least a client-based operating system.

### SUMMARY

In an embodiment, a system and method are provided for providing remote access to a software application over a communication network. In an embodiment, user information and authentication information are stored. An information processor provides a first instance of the software application to a computing device and captures a video stream associated with the first instance of the software application. The captured video stream is processed to provide a data stream that is interpretable by a web browser. The data stream is sent to the browser, and a second data stream is received that represents input from a user of the browser. The second stream is decoded and the input represented by the stream is entered into the software application.

Other features and advantages of the present application will become apparent from the following description of the invention that refers to the accompanying drawings.

### BRIEF DESCRIPTION OF THE DRAWINGS

For the purpose of illustrating the invention, there is shown in the drawings several forms, which are presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates an example hardware arrangement, in accordance with an embodiment of the present application;

FIG. 2 illustrates functional elements, of which one or more may be configured in a computing device, in accordance with an embodiment;

FIG. 3 illustrates an example hardware and software architecture in accordance with an embodiment;

FIG. 4 illustrates an example display that includes features provided in accordance with an example embodiment;

FIG. 5 is a flowchart showing example steps in accordance with an embodiment;

FIG. 6 is a flowchart showing example steps associated with an alternative embodiment; and

FIG. 7 is another flowchart showing example steps associated with an embodiment in accordance with the present application.

### DESCRIPTION OF THE EMBODIMENTS

The present application provides a solution to the above-identified shortcomings, for example, by providing for remote access to a plurality of software applications for a plurality of computing devices, such as client devices, that operate standard web-browsing software and that do not require customization (e.g., plug-ins). In an embodiment, a respective software application that is accessed and/or operated by a “client” computing device does not have the application installed thereon. Further, unlike known systems, the present application does not require that the hosted application be customized or written for a particular client device or environment.

Also unlike known systems, any end-user software application, including office applications (e.g., word processing application, spreadsheet application, presentation application, database application, tax application), entertainment applications (e.g., gaming application), multimedia applications (e.g., computer-aided design (“CAD”) application, image editing application, audio editing application), which may be developed for general or vertical markets, are supported by the teachings herein and may be provided remotely over the Internet. In a preferred embodiment, client-side web browser software applications that may access and operate a web hosted application in accordance with the present application are compliant to operate at least version 5 of the hypertext markup language (“HTML5”), which inherently includes functionality that, in earlier versions of HTML, required client applications (e.g., web browser software applications) to be configured with FLASH, SILVERLIGHT and/or other plug-in.

Thus, the present application provides a remote software application accessing and sharing technology that is available for computing devices to operate standard web browsing software application that is HTML5 compliant and that does not require a particular plug-in (e.g., FLASH, SILVERLIGHT or the like) for operation. In accordance with an embodiment of the present application, a computing device refers, generally, to any computing device that is capable of operating an HTML5 compliant web browser software application, such as a personal computer, gaming system, tablet computing device, smartphone or other mobile device.

In accordance with the teachings herein, virtually any software application may be accessed, operated or otherwise shared remotely, such as over the Internet or a wide area network (“WAN”), without any requirement for additional software installation or customization in the web browser. Moreover, the present application precludes the need for additional managing of firewall or other security measures. This is provided, at least in part, due to the inherent functionality of HTTP. By eliminating a need for additional firewall settings, such as enabling or disabling firewall ports, the present application reduces costs and management concerns. Thus the present application provides a secure, convenient and cost-effective way for application sharing, such as over the Internet or over a wide area network or local area network.

In addition to providing secure and remote accessibility to software applications and data, the present application provides for centralized application management, which lowers maintenance cost. Managers are relieved of having to take different operating system into account, which also has a positive effect on maintenance costs. Thus, the cost of hardware associated with implementing the teachings herein is typically lower than that of prior art. Since a computing device may operate only a web browser software application, no proprietary, expensive and/or cumbersome hardware and software is needed.

In accordance with the present application, one or more software applications are centrally managed, which contributes to simplify resource management and lowers costs, including operation and management costs. User data, such as documents, spreadsheets, presentations, image files, audio files or content provided in other data formats, may also be stored and/or managed via one or more “server” computing devices. In addition, the teachings herein provide for centralized backup and archiving for storage and management of data, which also lowers costs.

Further and in an embodiment, the present application supports virtually any number of concurrent end users accessing one or a plurality of software applications that are provided on one or more web servers. For example, thousands of computing devices may access hundreds of software applications. Each computing device that establishes an HTTP session with a web server hosting a web software application in accordance with the teachings herein may access a software application and data that may be respectively associated with the user. For example, a user connects to a web server that is hosting a word processing software application in accordance with the teachings herein, and the user submits authentication information (e.g., user name and password) for establishing a secure data/communication session with the server. As the user accesses the word processing software application, documents associated with the user are available for use, including for editing, printing, or the like.

In an embodiment, a web server runs a software application, such as MICROSOFT WORD, and the computing device using a HTML5 compliant web browser software application runs the application via the browser. In an embodiment, in response to a request from the workstation, the software application is executed on the server. The native GUI stream from the software application is encoded, for example, by the web server or other associated computing device (or service) and, thereafter, is sent as a data stream to the computing device and presented in the workstation's web browser.

Continuing with reference to this example embodiment, as the user interacts with the web server during the HTTP session, the user's inputs (e.g., keyboard/mouse actions) are recognized via HTML5 elements and the user's input stream is transmitted to the web server. A software component running on the web server translates the user's input stream into keyboard/mouse events, which are then sent to the software application. The software application responds in accordance with its “native” functionality. In this way, a user is able to access the software remotely via just an HTML5 compliant browser, without a need for additional software, i.e., FLASH or other plug-ins, and without having to install or operate other client software associated with the software application running on the server. Thus, remote access to a software application over the Internet is provided by encoding a graphical user interface (“GUI”) stream that is sent as a data stream and interpreted in a native HTML5 web browser software application.

It is recognized by the inventor that video encoding is data and processing intensive. In an embodiment in which video encoding occurs on the same machine (e.g., the web server) as the machine running the shared software application, measures are taken to ensure that sufficient processing power is available for the encoding process. In an embodiment, core management is provided on multi-core processor (and powerful core processor) machines. Alternatively, dedicated hardware encoding cards may be provided. In yet another embodiment, utilization of a computing device's graphics board (e.g., via OpenGL or CUDA) is provided. Alternatively, if a software application process and a video encoding process run on different devices, the present application supports transporting the captured data to the encoding process.

Occasionally, processing a video may be undesirable, such as due to data and processing limitations. In an alternative embodiment, a video stream is not processed, and a succession of single image frames representing the output of an application's graphical user interface are obtained and used for providing remote access to the application. In an embodiment, a delta is determined between application states (e.g., “window changes”) and differing parts are encoded into compressed images, such as JPEG images. The images, which herein are referred to, generally, herein as “frames,” include the differences between a respective application's states during operation, and are encapsulated and transmitted, substantially as shown and described herein. By transmitting images representing changes in application states, the amount of overhead needed to provide remote access to an application is significantly reduced. This alternative embodiment is useful, for example, in cases of limited bandwidth, memory, processing ability or other encountered limitation.

In accordance with an embodiment, rapid encoding of video and transmission of video is provided, which decreases latency periods in the network between the computing device and the web (or other) server. This contributes to a virtually seamless operating environment for a user.

It is recognized by the inventor that system capturing and compressing image data, including for example, “screenshots” may also be data-intensive. Occasionally, a data stream may be too large to be transferred, for example, by a gigabit Ethernet controller if, for example, compression of the data stream is done on a machine other than where the shared software application runs. Accordingly, the present application provides for improved performance, such as via a network connection using fiber optics, or an extension of the system bus. Moreover, the amount of necessary bandwidth may not be constant over time. If, for example, an application is computing only to produce a graphic of a changing progress bar, the required bandwidth will be minimal. Thus, there are differing concerns in connection with running a software application, providing video encoding, transmission, or the like.

One commonly used video compression format is H.264/MPEG-4 AVC (hereinafter “H.264”), which may be suitable in accordance with an embodiment. It is recognized by the inventor that H.264 may not be well supported by a particular web browser software application. Accordingly, the present application may support WebM for suitable video compression for use with HTML5 video. WebM may be particularly useful, as it is open source software and is compliant with HTML5. In an alternative embodiment, image information received by a client device may be presented via the canvas tag, to draw the received image data for presentation to the end user.

As noted above and in an embodiment, an application video stream that is operating on a server computing device, such as a web server, is captured. Referred to herein, generally, as “hooking the display,” sound and input of enterprise applications may be accessed and processed for conversion to one or more data streams and transmitted to one or more thin clients, including computing devices operating HTML5 compliant web browser software applications.

Further, the present application supports capturing user input and events that occur via a computing device that, in non-HTML5 web browser software applications could not be captured without a suitable plug-in. Further, keyboard events that are assigned special functions in a web browser software application, such as ctrl+w to close a window or a “right mouse-click” for providing a context menu, are supported herein. Various input events, such as keystrokes and selections generated by a keyboard and/or mouse and keyboard are captured in an HTML5-compliant web browser. For example, a mouse event (e.g., “right mouse click”) or keyboard combination (e.g., “Ctrl+W”) is recognized via script functionality supported in an HTM5 compliant web browser software application, and information representing the event and/or keyboard combination is transmitted to the server for use in the respective software application.

The present application also precludes automatic and unsolicited browser upgrades from negatively impacting remote application accessibility and usability. In addition, the present application ensures that users who may inadvertently (or intentionally) install plug-ins or install upgrades to a web browser do not negatively impact remote application accessibility and usability. This may occur inherently by a particular web browser software application, as manufacturers of web browser software applications often employ extensive security measures to prevent plug-ins or upgraded versions from interfering with core browser technology

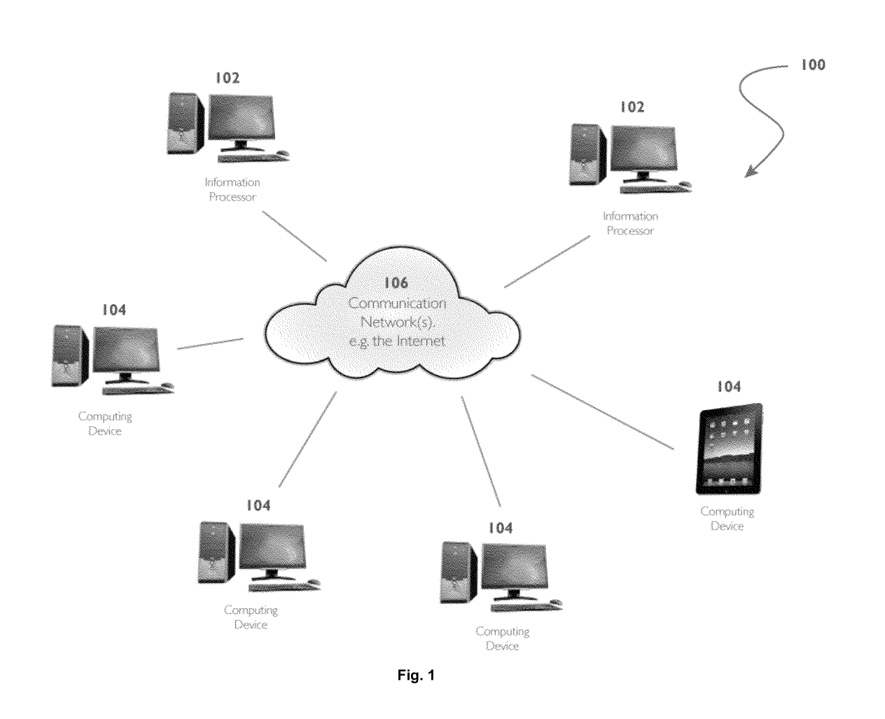

Referring now to the drawing figures, in which like reference numerals represent like elements, FIG. 1 illustrates an example hardware arrangement in accordance with an embodiment of the present application. Referred to generally, herein, as system 100, the arrangement provides for shared software application services in accordance with the teachings herein. System 100 includes at least one information processor 102 (configured to operate as an Internet web server and/or database file server) that is programmed and configured to access communication network 106 and communicate with computing device(s) 104. Computing devices 104 may be personal computers, and may further be mobile devices, such as operating one or more of the GOOGLE ANDROID, APPLE IOS, WINDOWS MOBILE operating systems, and may include smartphone devices, tablet computing devices, other mobile portable devices. Computing devices 104 and information processor(s) 102 may communicate via the known communications protocol, Transmission Control Protocol/Internet Protocol “TCP/IP.” Information processor 102 and computing device(s) 104 preferably are provided with or have access to all databases necessary to support the present application.

Communication network 106 is preferably a global public communication network such as the Internet, but can also be a wide area network (WAN), local area network (LAN), an intranet or other network that enables computing devices and peripheral devices to communicate.

In a preferred embodiment, information processor(s) 102 and computing devices 104 may be equipped with web browser software, such as MICROSOFT INTERNET EXPLORER, MOZILLA FIREFOX, APPLE SAFARI, GOOGLE CHROME or the like. Information processor 102 and computing devices 104 are coupled to communication network 106 using any known data communication networking technology.

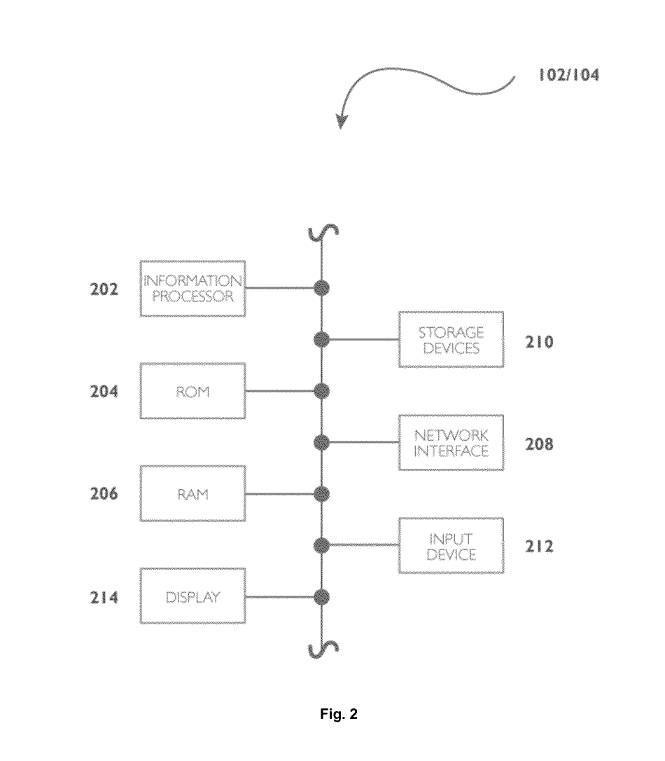

FIG. 2 illustrates functional elements, of which one or more may be configured in an example information processor 102 and/or computing device 104. The functional elements shown in FIG. 2 include one or more central processing units (CPU) 202 used to execute software code and control operations. Other elements shown in FIG. 2 include read-only memory (ROM) 204, random access memory (RAM) 206, one or more network interfaces 208 to transmit and receive data to and from other computing devices across a communication network, storage devices 210 such as a hard disk drive, floppy disk drive, tape drive, CD ROM or DVD for storing program code databases and application data, one or more input devices 212 such as a keyboard, mouse, track ball, microphone and the like, and a display 214.

The various components illustrated in FIG. 2 need not be physically contained within a single device chassis or even located in a single location. For example, storage device 210 may be located at a site that is remote from the remaining elements of information processor 102, and may even be connected to CPU 202 across communication network 106 via network interface 208. Information processor 102 and/or computing device 104 may include a memory equipped with sufficient storage, such as to provide or access the necessary databases, forums, and other community services communicating hypertext markup language (HTML), Java applets, and/or Active-X control programs. Information processor 102 and/or computing device 104 are arranged with components, for example, those shown in FIG. 2, suitable for the expected operating environment. The CPU(s) 202, network interface(s) 208 and memory and storage devices are selected to ensure that capacities are arranged to accommodate expected demand.

The nature of the present application is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, MYSQL, PHP and RUBY ON RAILS.

Although the present application is described by way of example herein and in terms of a web-based system using web browsers and a web site server (e.g., information processor 102), system 100 is not limited to such a configuration. It is contemplated that system 100 is arranged such that information processor 102 and/or computing devices 104 communicate with and outputs data using any known communication method, for example, using a non-Internet browser WINDOWS viewer coupled with a local area network protocol such as the Internet Packet Exchange (IPX), dial-up, third-party, private network or a value added network (VAN). Moreover, information processor 102 and/or computing devices 104 may communicate via an application developed to run on the iOS or ANDROID operating systems.

It is further contemplated that any suitable operating system can be used on information processor 102 and/or computing device 104, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, WINDOWS VISTA, WINDOWS 7, MAC OS, UNIX, LINUX, PALM OS, POCKET PC, BLACKBERRY, ANDROID, IOS, WEB OS and any other suitable operating system.

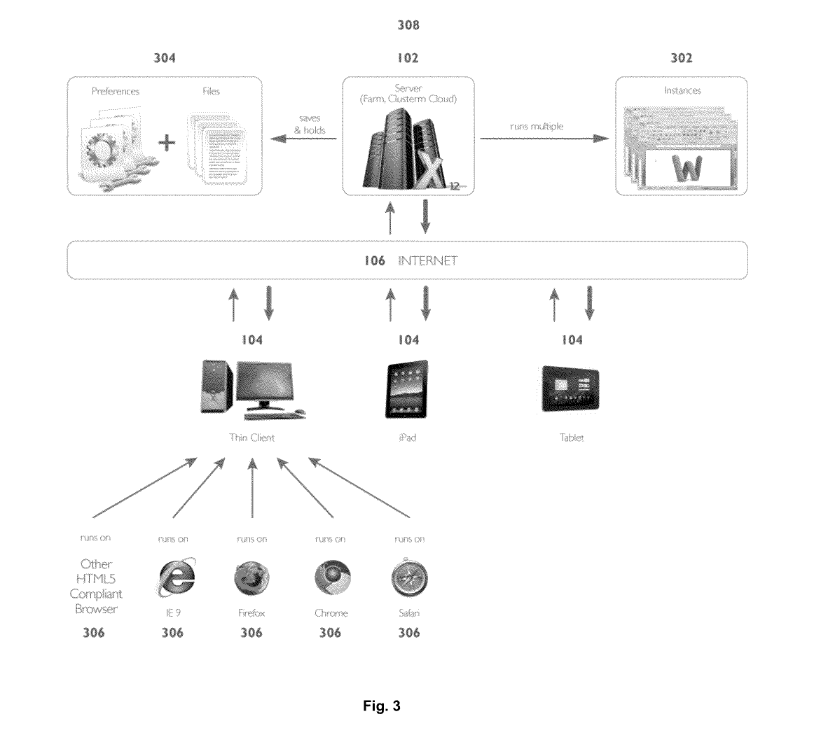

FIG. 3 illustrates another example architecture in accordance with an embodiment. As illustrated in the example embodiment in FIG. 3, information processor(s) 102 may be configured as a farm, a cluster of servers or other “cloud” based architecture. Information processor 102 accesses and runs any number of a plurality of software application programs 302, and each respective program 302 is operative to run in a respective one of a plurality of instances. Data 304 that may be generated and/or edited via program 302 can be respectively obtained and/or saved by information processor 102. In an embodiment, a user logs into information processor 102, for example by submitting a user name and password, and information processor 102 manages that user's respective data.

Continuing with reference to FIG. 3, information processor 102 sends and receives information via communication network 106 to and from computing devices 104. In the example shown in FIG. 3, computing devices 104 are illustrated as a “thin client,” IPAD and tablet computing device. As noted above, any suitable computing device that is capable, for example, of running an HTML5 compliant web browser may be a suitable computing device 104. In the example shown in FIG. 3, example web browser software applications 306 are shown and include INTERNET EXPLORER 9, FIREFOX, CHROME AND SAFARI.

In operation and in connection with the example shown in FIG. 3, information processor 102 operates software application 302 and application's 302 GUI-stream is encoded, for example, by information processor 102 or other device. The encoded GUI stream is provided as a data stream that is sent to computing device(s) 104, which decodes the stream and presents it in the computing device's 104 respective web browser software application 306.

Continuing with the example shown in FIG. 3, HTML5 code running in web browser software application 306 captures user input as a user interacts with the software application 302, and the captured input is delivered as an input data stream to information processor 102. A component operating thereon translates the incoming data-stream into keyboard and mouse events for the respective software application 302 with which the user is interacting. In this way, remote computing is provided for computing devices, for example, operating HTML5 compliant software platforms, and without a need for proprietary plug-ins, additional software and/or hardware components at the client side or the server side.

As noted above, application software 302 and data for respective users is managed as a function of one or more components in association with information processor 102.

In an embodiment, applications that are provided for remote access in accordance with the teachings herein are encapsulated in one or more instances (as known in the art) of server operating system software. Software applications are be deployed to these instances through suitable deployment technology that is integrated with server operating system software, such as provided in the MICROSOFT WINDOWS SERVER range of operating systems. Users may receive the required applications as purchased through mediation of a database, as known in the art. Customer purchases made and available applications may be managed via respective locations within a centralized deployment and storage system. In this way, updates can be rolled-out as desired without significant (or any) additional effort.

In an embodiment, each user is assigned an encrypted, individual storage space container (“virtual disk image”), which may be stored on a centralized storage system and may be activated and served to the user when the user logs into the system. Continuing with this embodiment, the system may make this container accessible (“mount”) to the user as a virtual local disk drive. Once accessed, users are free to use their respective, e.g., pre-sized containers until the assigned storage space (“quota”) is exceeded. In the event that the user exceeds his/her predefined storage limits, additional storage space may be allotted, for example, for purchase.

In an embodiment, bi-directional communications channels are provided over a single Transmission Control Protocol (TCP) socket, and provided by the WebSocket application programming interface (“API”). The WebSocket API is useful to implement communication from the browser to the servers. As noted above, in an embodiment H.264 codec is used as a video codec, and is provided in conjunction with the WebSocket API.

In an embodiment, a video stream that is provided by information processor 102 to one or more computing devices 104 is encrypted to provide security. Encrypting the video stream provided in accordance with the teachings herein ensures that confidential information is transmitted securely between information processor 102 and computing device 104. Encryption of the video stream or image frame transport layer may be provided by means of Secure Socket Layer/Transport Layer Security (SSL/TLS) implementation. SSL/TLS is a well-tested industry standard used in web services, streaming security, and more.

In order to provide different applications to computing devices 104, a form of virtualization is provided to scale, according to respective demand. For example, a plurality (e.g., dozens) of virtual processors are supported via a terabyte or more of random access memory 206. The use of server virtualization enables system-scaling to serve large numbers of users, independently and on one physical machine. This in turn ensures lasting scalability, stability, unified performance and reduced total cost of ownership.

As used herein and in an embodiment, the term, “virtualization” refers to applying an additional software separation layer to the physical server infrastructure, serving as an intermediary between the physical hardware and the server operating system, e.g. WINDOWS SERVER 2008. The virtualization layer provides an abstract interface for negotiation between the server operating system and the physical hardware. This layer unifies system resources and, further, allocates these resources to virtual, software-controlled hardware-type instances. Each of these hardware-type instances can be scaled to fit the use-case, as desired. Moreover, each instance can be controlled independently. This ensures that in the event of any computing complication, such as a “fatal error,” only the faults within one single instance will have to be addressed. The remaining instances, albeit maintained by the same physical hardware, remain unaffected by any such faults.

Additionally, the use of virtualization technology allows for “cloning” of the aforementioned instances across geographically distant datacenters, thereby allowing for a grand unified operation architecture and wide-scale server orchestration at a significantly reduced cost. A possible embodiment may make use of industry standard products such as VMWARE VSPHERE HYPERVISOR (ESXI), or MICROSOFT HYPER-V.

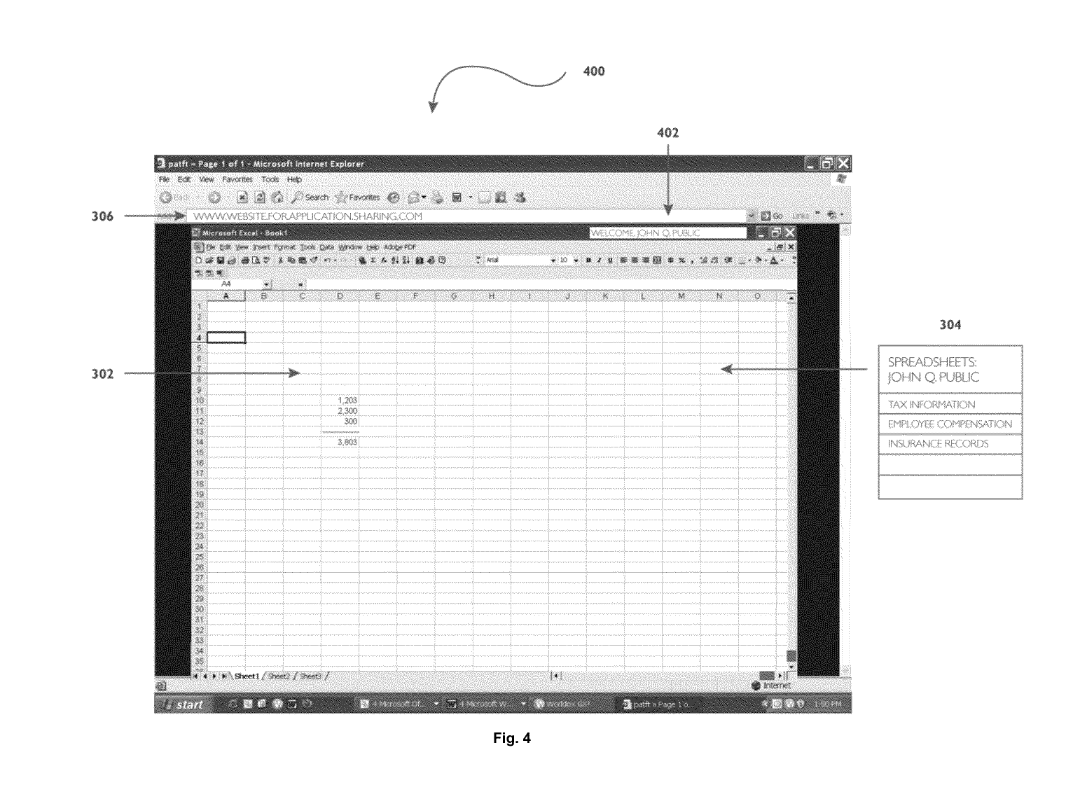

FIG. 4 illustrates an example display screen 400 in accordance with an embodiment of the present application that is provided to a user (illustrated as “John Q. Public”) who has submitted authentication information, such as a user name and password, and is effectively “logged in” to information processor 102. As shown in FIG. 4, greeting 402 identifies the user by name, thereby ensuring the user is reviewing data that belongs to him/her. Moreover, the respective software application illustrated in FIG. 4 is a spreadsheet application, MICROSOFT EXCEL, and a list of data files 304 is provided for the user. As a function of data management provided by information processor 102, files 304 that are listed for the user are spreadsheet files, and not other files, such as documents and/or image files, that may also belong to the user. Of course, alternative displays and data access measures are supported in accordance with the teachings herein, as options may be provided for the user to access data files of other types (e.g., document files, image files, audio files or the like) that respectively belong to or are otherwise associated with the user. Thus, as illustrated in FIG. 4, a spreadsheet software application 302 is instantiated in web browser software application 306, and accessible to computing device 104 over communication network 106.

In an embodiment, a list of a plurality of files of different types is provided. A user selection of a file having a respective data file type causes information processor 102 to spawn an instance of a software application that corresponds (or is associated) with that file type. Selecting a document file, for example, causes a word processor application to launch. Such instance may be provided either initially when a user “logs in,” or may be provided thereafter while the user is working on or otherwise reviewing a different software application. Moreover, the present application may support simultaneous instances of different software applications in a single web browser display screen. Such multi-tasking functionality may be provided for integration of various applications, such as drag-and-drop functionality of data from a word processing software application into a spreadsheet software application. A plurality of applications may be provided simultaneously for increased functionality.

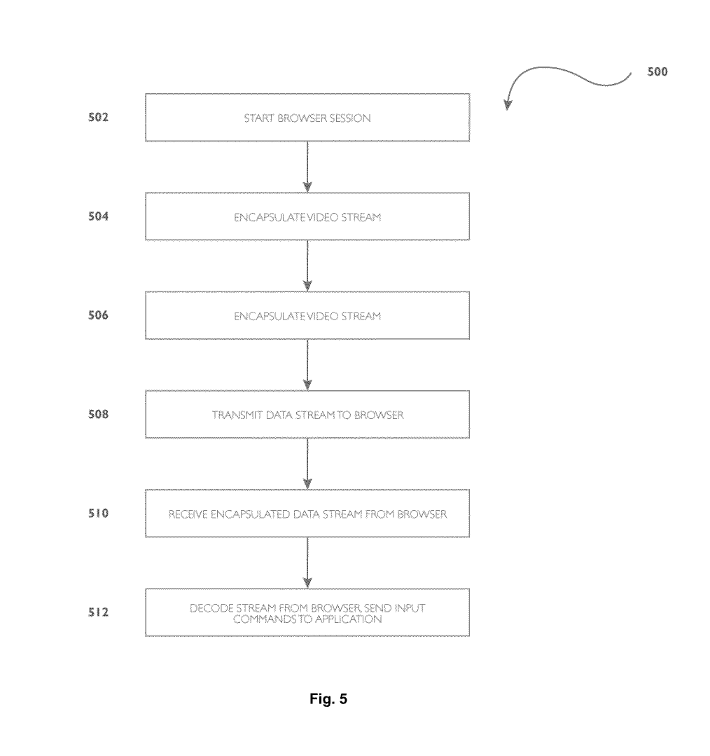

FIG. 5 is a flowchart showing example steps 500 in accordance with an embodiment. At step S02, a session is started by information processor 102 with computing device 104. In the example shown in FIG. 5, the session with computing device 104 is an HTTP session, and user computing device 104 is operating a web browser. At step S04, a software application instance is started by information processor 102 for access by user computing device 104. Thereafter, the video stream that is output from the graphical user interface of the software application is captured and encapsulated by information processor 102 (step S06). The encapsulated video stream, which may be formatted as a data stream, is transmitted by information processor 102 to the computing device 104 (step S08). Thereafter, as the user operating user computing device 104 interfaces in the HTML5 compliant browser that is displaying a representation of the software application in connection with the encapsulated video stream, input, such as key strokes and mouse events, are detected and encoded into a data stream, which is transmitted to and received by information processor 102 (step S10). Thereafter, information processor 102 decodes the stream from the browser, and sends the input represented therein to the software application (step S12). Thereafter, the process branches back to step S504. In this way, an embodiment of remote access to software applications is provided in accordance with the present application.

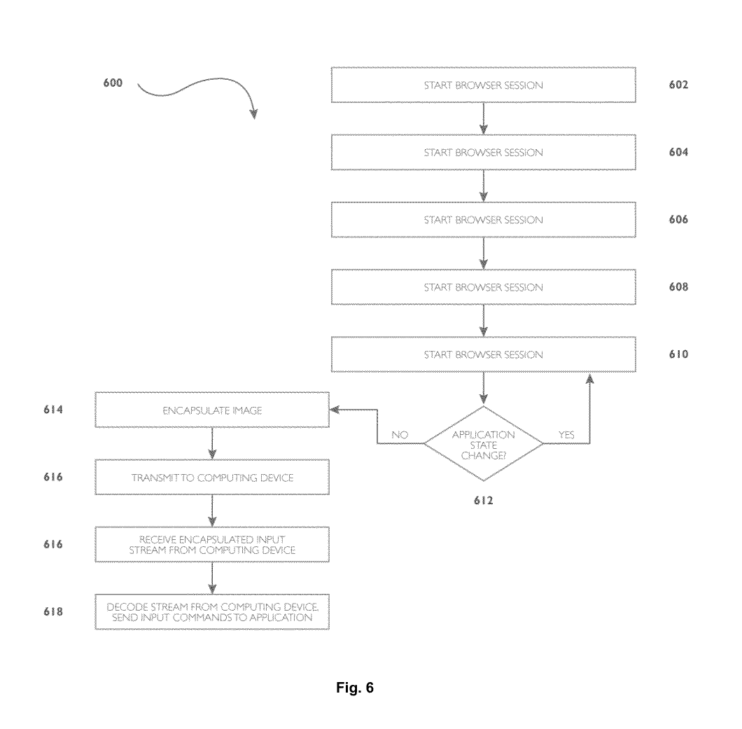

FIG. 6 is a flowchart showing example steps 600 associated with an alternative embodiment. In step 602, an instance of the software application is started by information processor 102. Thereafter, an image of the application is captured, for example, via the video output stream associated with the graphical user interface of the application (step 604). The image is, thereafter, encapsulated (step S606) and the encapsulated image is transmitted to the browser in step S608. Thereafter, a second image of the application state is taken (step 610). A determination is made, thereafter, whether the state of the application has changed since the previous image was captured (step 612). If the state of the application had not changed, then the process branches back to step 610 and another image is captured. If, on the other hand, the determination in step 612 is that the state of the application had changed, then the new image of the application is encapsulated (step 614). At step 615, the new encapsulated image is transmitted to the browser (step 616). Thereafter, as the user operating computing device 104 interfaces with the web browser, input, such as key strokes and mouse events, are captured, encapsulated and transmitted from the computing device 104 to information processor 102 (step 618). The input stream is decoded by information processor 102, and input commands associated with the application are transmitted by information processor 102 into the software application (step 620). Thereafter, the process loops back to step 610.

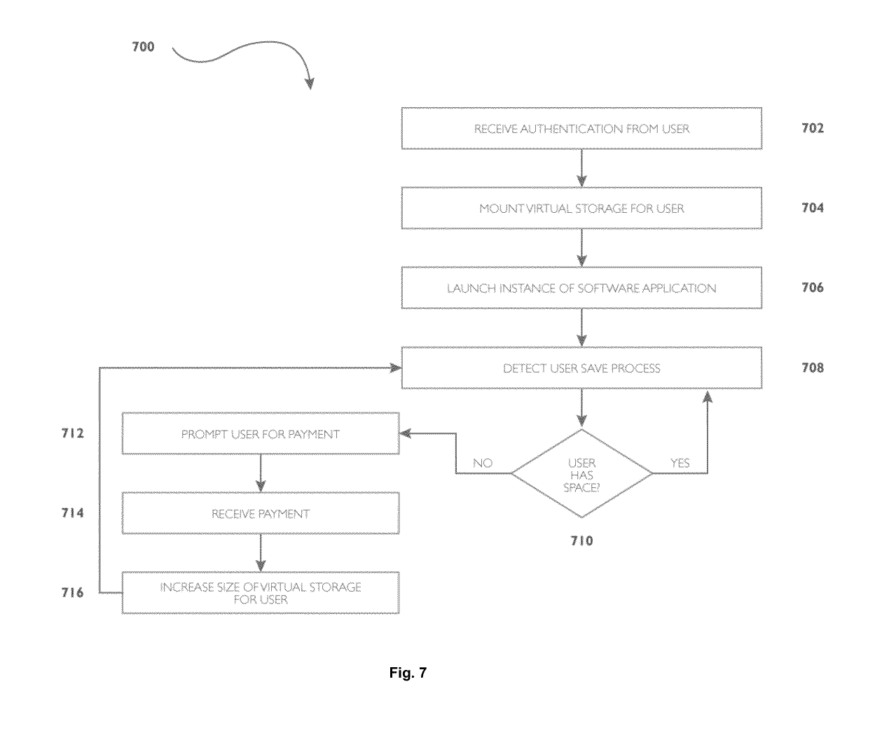

FIG. 7 is another flowchart showing example steps 700 associated with an embodiment in accordance with the present application. At step 702, authentication information from a user operating a computing device 104 is received by information processor 102. Once the user is authenticated, virtual storage space is mounted by information processor 102 for the user (step 704). Once the storage is mounted for the user, an instance of the software application is launched by information processor 102, for access by the user computing device 104 (step 706). As the user interacts in accordance with the present application with the software application, a save process, such as to save a particular file, is detected by information processor 102 (step 708). At step 710, a determination is made by information processor 102 whether the user has sufficient space in his or her virtual storage. If so, then the process branches back to step 708, until another save process is detected by information processor 102. Alternatively, if the determination in step 710 is that the user has insufficient space to save the respective file that the user is working on, then the user is prompted by information processor 102 to submit a payment for additional space (step 712). Thereafter, in step 714, payment is received by the user and the size of the virtual storage is thereby increased by information processor 102 step 716. Thereafter, the process branches to step 708 until another save process is detected. In this way, information processor 102 can manage virtual space allocated for respective users to ensure that overhead is managed appropriately and efficiency of the system is maintained.

Thus, and in accordance with the teachings herein, a system and method for application sharing and use is provided at lower total cost of ownership, and made available to a broader range of clients. Running multiple applications on one or more information processors 102 results in less resource and power consumption on the client side, thereby promoting energy efficiency.

Moreover, a plurality of usage fee and licensing arrangements is supported according to the teachings herein. For example, users may be charged for software use on a per-use basis, or a per-time period basis (e.g., daily, weekly, monthly or annually). In yet another embodiment, users may be charged for use as a function of resource consumption (e.g., bandwidth, data, processing, time of use or the like). The more resource intensive the use, the higher the cost to the user. Other licensing variables may be factored as well, such as a particular time of day (e.g., times of lower population usage are less expensive), particular days of the week (e.g., week-end charges are higher (or lower) than week-day charges), holidays and even months during the year (e.g., summer months cost less (or more) than winter months). Thus, various business models are supported by the present application that may relate to time, use or other variable that may be suitable for a proprietor of the present application, and/or provider of a respective software application 302.

The present application provides many benefits over previously known methods for remote and/or shared access to software application. Accessibility to software is substantially increased as a function of the teachings herein, as are significantly lower costs of ownership. Further, environmental benefits are envisioned, as fewer resources are needed per user computing device than in previously known systems. Further, management and maintenance of computing device resources, such as operating system requirements, client software plug-in and other proprietary software requirements, are markedly reduced by the present application. Moreover, individual user data and software usage managed in a centralizing environment, which improves management of such resources and similarly lowers costs.

Although the present application is described and shown in relation to particular embodiments thereof, many other variations and modifications and other uses will become apparent to those skilled in the art. Thus, various embodiments and variations are shown and described herein, and it is preferred, therefore, that the present invention be limited not by the specific disclosure herein.

What is claimed is:

1. A method for providing remote access to a software application over a communication network, the method comprising:
storing in at least one database operatively coupled to at least one information processor:
user information representing a plurality of users; and
authentication information respectively associated with each of the plurality of users, wherein the authentication information entitles each of the users to access to at least one respective software application;
receiving, by the at least one information processor and from a first user computing device associated with a first user, first authentication information associated with the first user;
determining, by the at least one information processor as a function of the first authentication information, that the first user is entitled to access to the software application;
providing, by the at least one information processor, a first instance of the software application;
capturing, by the at least one information processor, a first video stream associated with the first instance of the software application;
processing, by the at least one information processor, the captured first video stream to provide a first data stream, wherein the first data stream is interpretable by a web browser software application as the first captured video stream;
sending, by the at least one information processor to the first user computing device, the first data stream;
receiving, by the at least one information processor from the first user computing device, a second data stream that represents input from the first user;
decoding, by the at least one information processor, the second data stream; and
entering, by the at least one information processor the input represented by the second data stream into the instance of the software application.

2. The method of claim 1, further comprising:
receiving, by the at least one information processor and from a second user computing device associated with a second user, second authentication information associated with the second user;
determining, by the at least one information processor as a function of the second authentication information, that the second user is not entitled to access to the software application; and
precluding, by the at least one information processor as a function of the second authentication information, access to the software application by the second user computing device.

3. The method of claim 1, further comprising:
receiving, by the at least one information processor and from a second user computing device associated with a second user, second authentication information associated with the second user;
determining, by the at least one information processor as a function of the second authentication information, that the second user is entitled to access to the software application;
providing, by the at least one information processor, a second instance of the software application;
capturing, by the at least one information processor, a second video stream associated with the second instance of the software application;
processing, by the at least one information processor, the captured second video stream to provide a third data stream, wherein the third data stream is interpretable by a web browser software application as the captured second video stream;
sending, by the at least one information processor to the second user computing device, the third data stream;
receiving, by the at least one information processor from the second user computing device, a fourth data stream that represents input from the second user;
decoding, by the at least one information processor, the fourth data stream; and
entering, by the at least one information processor the input represented by the fourth data stream into the second instance of the software application.

4. The method of claim 1, further comprising:
receiving, by the at least one information processor and from a second user computing device associated with a second user, second authentication information associated with the second user;
determining, by the at least one information processor as a function of the second authentication information, that the second user is entitled to access to an other software application;
providing, by the at least one information processor, a first instance of the other software application;
capturing, by the at least one information processor, a second video stream associated with the first instance of the other software application;
processing, by the at least one information processor, the captured second video stream to provide a third data stream, wherein the third data stream is interpretable by a web browser software application as the captured second video stream;
sending, by the at least one information processor to the second user computing device, the third data stream;
receiving, by the at least one information processor from the second user computing device, a fourth data stream that represents input from the second user;
decoding, by the at least one information processor, the fourth data stream; and
entering, by the at least one information processor the input represented by the fourth data stream into the first instance of the other software application.

5. The method of claim 1, wherein the software application includes at least one selected from a group consisting of computer aided design software, word processing software, spreadsheet software, database software, accounting software and multimedia software.

6. The method of claim 1, wherein the web browser software application is compliant with HTML5.

7. The method of claim 1, further comprising allocating, by the at least one information processor, virtual storage space for the first user computing device.

8. The method of claim 7, further comprising receiving, by the at least one information processor, payment for the virtual storage space.

9. The method of claim 7, further comprising:
receiving, by the at least one information processor from the first user computing device, a request to store information in the virtual storage space;
determining by the at least one information processor, that the virtual storage is insufficient to store the information;
receiving, by the at least one information processor, payment for increasing the virtual storage space.; and
increasing, by the at least one information processor, the virtual storage space as a function of the payment.

10. The method of claim 1, further comprising detecting, by the at least one information processor, at least one change in a state of the software application, wherein the transmitting of the video stream is provided in response to the change in the state.

11. A system for providing remote access to a software application over a communication network, the method comprising:
at least one information processor operatively coupled to the one or more processor at least one database stored on the one or more processor readable media that includes:
user information representing a plurality of users; and
authentication information respectively associated with each of the plurality of users, wherein the authentication information entitles each of the users to access to at least one respective software application;
the at least one information processor having instructions for causing the following steps to be performed by the at least one information processor:
receiving, by the at least one information processor and from a first user computing device associated with a first user, first authentication information associated with the first user;
determining, by the at least one information processor as a function of the first authentication information, that the first user is entitled to access to the software application;
providing, by the at least one information processor, a first instance of the software application;
capturing, by the at least one information processor, a first video stream associated with the first instance of the software application;
processing, by the at least one information processor, the captured first video stream to provide a first data stream, wherein the first data stream is interpretable by a web browser software application as the first captured video stream;
sending, by the at least one information processor to the first user computing device, the first data stream;
receiving, by the at least one information processor from the first user computing device, a second data stream that represents input from the first user;
decoding, by the at least one information processor, the second data stream; and
entering, by the at least one information processor the input represented by the second data stream into the instance of the software application.

12. The system of claim 11, wherein the at least one information processor further has instructions for causing the following steps to be performed by the at least one information processor:
receiving, by the at least one information processor and from a second user computing device associated with a second user, second authentication information associated with the second user;
determining, by the at least one information processor as a function of the second authentication information, that the second user is not entitled to access to the software application; and
precluding, by the at least one information processor as a function of the second authentication information, access to the software application by the second user computing device.

13. The system of claim 11, wherein the at least one information processor further has instructions for causing the following steps to be performed by the at least one information processor:
receiving, by the at least one information processor and from a second user computing device associated with a second user, second authentication information associated with the second user;
determining, by the at least one information processor as a function of the second authentication information, that the second user is entitled to access to the software application;
providing, by the at least one information processor, a second instance of the software application;
capturing, by the at least one information processor, a second video stream associated with the second instance of the software application;
processing, by the at least one information processor, the captured second video stream to provide a third data stream, wherein the third data stream is interpretable by a web browser software application as the captured second video stream;
sending, by the at least one information processor to the second user computing device, the third data stream;
receiving, by the at least one information processor from the second user computing device, a fourth data stream that represents input from the second user;
decoding, by the at least one information processor, the fourth data stream; and
entering, by the at least one information processor the input represented by the fourth data stream into the second instance of the software application.

14. The system of claim 11, wherein the at least one information processor further has instructions for causing the following steps to be performed by the at least one information processor:
receiving, by the at least one information processor and from a second user computing device associated with a second user, second authentication information associated with the second user;
determining, by the at least one information processor as a function of the second authentication information, that the second user is entitled to access to an other software application;
providing, by the at least one information processor, a first instance of the other software application;
capturing, by the at least one information processor, a second video stream associated with the first instance of the other software application;
processing, by the at least one information processor, the captured second video stream to provide a third data stream, wherein the third data stream is interpretable by a web browser software application as the captured second video stream;
sending, by the at least one information processor to the second user computing device, the third data stream;
receiving, by the at least one information processor from the second user computing device, a fourth data stream that represents input from the second user;
decoding, by the at least one information processor, the fourth data stream; and
entering, by the at least one information processor the input represented by the fourth data stream into the first instance of the other software application.

15. The system of claim 11, wherein the software application includes at least one selected from a group consisting of computer aided design software, word processing software, spreadsheet software, database software, accounting software and multimedia software.

16. The system of claim 11, wherein the web browser software application is compliant with HTML5.

17. The system of claim 11, wherein the at least one information processor further has instructions for causing the following step to be performed by the at least one information processor:
allocating, by the at least one information processor, virtual storage space for the first user computing device.

18. The system of claim 17, wherein the at least one information processor further has instructions for causing the following step to be performed by the at least one information processor:
receiving, by the at least one information processor, payment for the virtual storage space.

19. The system of claim 17, wherein the at least one information processor further has instructions for causing the following steps to be performed by the at least one information processor:
receiving, by the at least one information processor from the first user computing device, a request to store information in the virtual storage space;
determining by the at least one information processor, that the virtual storage is insufficient to store the information;
receiving, by the at least one information processor, payment for increasing the virtual storage space.; and
increasing, by the at least one information processor, the virtual storage space as a function of the payment.

20. The system of claim 11, wherein the at least one information processor further has instructions for causing the following step to be performed by the at least one information processor:
detecting, by the at least one information processor, at least one change in a state of the software application, wherein the transmitting of the video stream is provided in response to the change in the state.
